(19) United States
(12) Patent Application Publication
(10) Pub. No.: US 2013/0110757 A1
(43) Pub. Date: May 2, 2013

(54) SYSTEM AND METHOD FOR ANALYZING ATTRIBUTE CHANGE IMPACT WITHIN A MANAGED NETWORK

(71) Applicants: Joël R. Calippe, San Jose, CA (US); Gurudas Somadder, San Jose, CA (US); Murali K. Velamati, Mountain View, CA (US); Ashok Sadasivan, Sunnyvale, CA (US); Sergio Colla, San Jose, CA (US); Paula N. Balus, Cupertino, CA (US)

(72) Inventors: Joël R. Calippe, San Jose, CA (US); Gurudas Somadder, San Jose, CA (US); Murali K. Velamati, Mountain View, CA (US); Ashok Sadasivan, Sunnyvale, CA (US); Sergio Colla, San Jose, CA (US); Paula N. Balus, Cupertino, CA (US)

(21) Appl. No.: 13/282,159

(22) Filed: Oct. 26, 2011

(51) Int. Cl. G06N 5/02

(52) U.S. Cl. 706/47

(57) ABSTRACT

A method and system for analyzing attribute change impact within a managed network by analyzing an attribute modification according to one or more rules to determine thereby a negative impact level associated with the attribute modification, where the rules include rules initially identified as relevant to the attribute and rules deterministically identified as relevant to said attribute.

### FIELD OF THE INVENTION

The invention relates generally to managing network resources such as in a wireless network and, more specifically but not exclusively, to analyzing attribute change impact within a managed network.

### BACKGROUND

A communication network comprises network elements and links that are physically and logically interconnected according to or in support of various protocols, services, applications, layers and so on.

Each of the devices, network elements or sub-elements, links or sub-links and so on within the network is typically associated with one or more attributes, properties and/or features. Some of these attributes, properties and/or features may be adapted via manual or automatic operations, such as by a network management system (NMS), element management system (EMS), local/native configuration program, replacement of network element components, upgrade (or downgrade) of network element hardware or software, removal of the network element from service and so on. Moreover, any adaptation of such attributes, properties and/or features may result in changes to the network element resulting in an undesired impact to functions or performance associated with other network elements.

For example, a base station such as an eNodeB within a Long Term Evolution (LTE) network has a number of attributes associated with it including a “signal strength” attribute. Any changes to the signal strength attribute may impact other attributes or operational properties of the eNodeB, user devices, Service Gateways (SGWs) or other routers in communication with the eNodeB, services supported by the eNodeB and so on.

When changing network element attributes such as at a network operations center (NOG), an operator must ensure that any provisioning or other process is implemented in a manner avoiding causing negative impact to the existing or new services. The main tool now used by operators to assess the impact of a proposed change is to use their previous experience.

### BRIEF SUMMARY

Various deficiencies of the prior art are addressed by the present invention of a method for assessing the impact of changes to attributes associated with a network element and responsively adapting a network management function.

One embodiment comprises a method and system for analyzing attribute change impact within a managed network by analyzing an attribute modification according to one or more rules to determine thereby a negative impact level associated with the attribute modification, where the rules include rules initially identified as relevant to the attribute and rules deterministically identified as relevant to said attribute.

### BRIEF DESCRIPTION OF THE DRAWINGS

The teachings of the present invention can be readily understood by considering the following detailed description in conjunction with the accompanying drawings, in which:

FIG. 1 depicts an exemplary wireless communication system including a management system according to an embodiment;

FIG. 2 depicts an exemplary management system suitable for use as the management system of FIG. 1;

FIG. 3 depicts a graphical representation of processes associated with various embodiments;

FIG. 4 depicts a flow diagram of a method according to one embodiment; and

FIG. 5 depicts a high-level block diagram of a computer suitable for use in performing functions described herein.

To facilitate understanding, identical reference numerals have been used, where possible, to designate identical elements that are common to the figures.

### DETAILED DESCRIPTION OF THE INVENTION

Embodiments of the invention will be primarily described within the context of a network management system (NMS) adapted to manage data objects associated with network elements, communications links, subnets, protocols, services, applications, layers and any other element, object or portion thereof within a Long Term Evolution (LTE) network.

However, while primarily discussed within the context of managing data objects representing network elements supporting mobile services within an LTE network or portions thereof, those skilled in the art and informed by the teachings herein will realize that the various embodiments are also applicable to managing data objects associated with other types of wireless networks (e.g., 3G networks, 2G networks, WiMAX, etc.), wireline networks or combinations of wireless and wireline networks. Thus, the network elements, links, connectors, sites and other objects representing mobile services may identify network elements associated with other types of wireless and wireline networks.

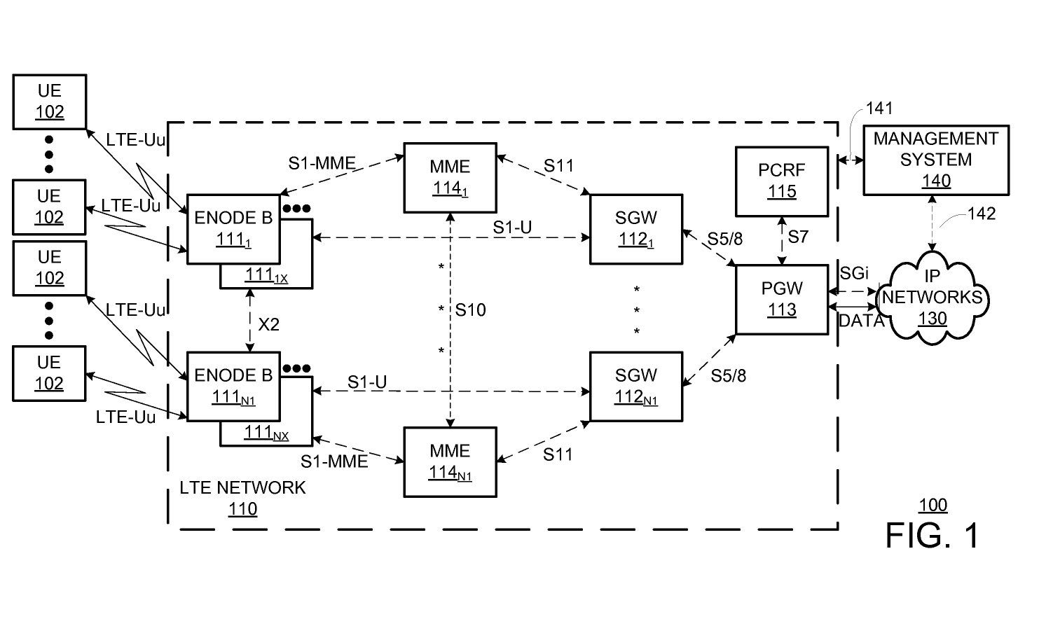

FIG. 1 depicts an exemplary wireless communication system including a management system according to an embodiment. Specifically, FIG. 1 depicts an exemplary wireless communication system 100 that includes a plurality of User Equipments (UEs) or User Devices (UDs) 102, a Long Term Evolution (LTE) network 110, IP networks 130, and a management system (MS) 140.

The LTE network 110 supports communications between the UEs 102 and IP networks 130. The MS 140 is configured for supporting various management functions for LTE network 110.

The UEs 102 are wireless user devices capable of accessing a wireless network, such as LTE network 110. The UEs 102 are capable of supporting control signaling in support of bearer session(s). The UEs 102 may be a phone, PDA, computer, or any other wireless user device.

The configuration and operation of LTE networks will be understood by one skilled in the art. The exemplary LTE network 110 includes a plurality of eNodeBs 111₁₁ through 111_{NX} (collectively, eNodeBs 111), a plurality of Serving Gateways (SGWs) 112₁₁ through 112_{N1} (collectively, SGWs 112), at least one Packet Data Network (PDN) Gateway (PGW) 113, a plurality of Mobility Management Entities (MMEs) 114₁ and 114_{N1} (collectively, MMEs 114), and at least one Policy and Charging Rules Function (PCRF) 115.

The eNodeBs 111, SGWs 112, PGW 113, MMEs 114, PCRF 115, as well as various LTE network components which have been omitted for purposes of clarity, cooperate to provide an Evolved Packet Core (EPC) network supporting end-to-end service delivery using IP.

The eNodeBs 111 provide radio access interface functions for the respective groups of UEs 102. As depicted in FIG. 1, each eNodeB 111 supports a respective plurality of UEs 102. The communication between the eNodeBs 111 and the UEs 102 is supported using LTE-Uu interfaces associated with each of the UEs 102.

The SGWs 112 support communications for various pluralities of eNodeBs 111. As depicted in FIG. 1, a first SGW 112 (denoted as SGW 112₁₁) is depicted as supporting communications for a first plurality of eNodeBs 111 (denoted as eNodeBs 111₁₁ through 111_{1X}), while an N^{th} SGW 112 (denoted as SGW 112_{N1}) is depicted as supporting communications for an N^{th} plurality of eNodeBs 111 (denoted as eNodeBs 111_{N1} through 111_{NX}). The communication between the SGWs 112 and their respective eNodeBs 111 is supported using S1-u interfaces. The S1-u interfaces support per-bearer user plane tunneling and inter-eNodeB path switching during handover. It will be appreciated that the SGWs 112 may support more or fewer eNodeBs then indicated.

The PGW 113 supports communications for the SGWs 112. The communication between PGW 113 and SGWs 112 is supported using respective S5/S8 interfaces. The S5 interfaces provide functions such as user plane tunneling and tunnel management for communications between PGW 113 and SGWs 112, SGW relocation due to UE mobility, and the like. The S8 interfaces, which may be Public Land Mobile Network (PLMN) variants of the S5 interfaces, provide inter-PLMN interfaces providing user and control plane connectivity between the SGW in the Visitor PLMN (VPLMN) and the PGW in the Home PLMN (HPLMN). The PGW 113 facilitates communications between LTE network 110 and IP networks 130 via, illustratively, an SGi interface.

The MMEs 114 provide mobility management functions in support of mobility of UEs 102. The MMEs 114 support the eNodeBs 111. The MME 114₁ supports eNodeB 111₁ and the MME 114₂ supports eNodeB 111₂. The communication between MMEs 114 and eNodeBs 111 is supported using respective S1-MME interfaces, which provide control plane protocols for communication between the MMEs 114 and the eNodeBs 111.

The PCRF 115 provides dynamic management capabilities by which the service provider may manage rules related to services provided via LTE network 110 and rules related to charging for services provided via LTE network 110.

As depicted in FIG. 1, elements of LTE network 110 communicate via interfaces between the elements. The interfaces described with respect to LTE network 110 also may be referred to as sessions.

The LTE network 110 includes an Evolved Packet System/Solution (EPS). In one embodiment, the EPS includes EPS nodes (e.g., eNodeBs 111, SGWs 112, PGW 113, MMEs 114, and PCRF 115) and EPS-related interconnectivity (e.g., the S* interfaces, the G* interfaces, and the like). The EPS-related interfaces may be referred to herein as EPS-related paths.

The IP networks 130 include one or more packet data networks via which UEs 102 may access content, services, and the like.

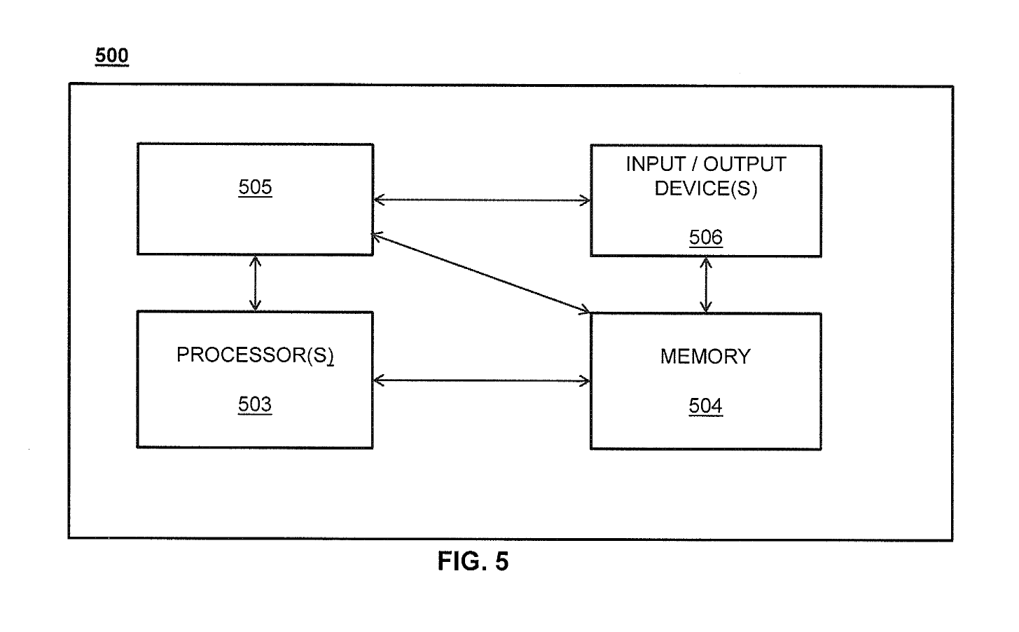

The MS 140 provides management functions for managing the LTE network 110. The MS 140 may communicate with LTE network 110 in any suitable manner. In one embodiment, for example, MS 140 may communicate with LTE network 110 via a communication path 141 which does not traverse IP networks 130. In one embodiment, for example, MS 140 may communicate with LTE network 110 via a communication path 142 which is supported by IP networks 130. The communication paths 141 and 142 may be implemented using any suitable communications capabilities. An exemplary management system suitable for use as MS 140 of FIG. 1 is depicted and described with respect to FIG. 5.

Generally speaking, the MS 140 is adapted to manage the above-described network elements including the UEs 102, eNodeBs 111, Serving Gateways (SGWs) 112, Packet Data Network (PDN) Gateway (PGW) 113, Mobility Management Entities (MMES) 114, and Policy and Charging Rules Function (PCRF) 115, as well as various other network elements (not shown) as well as the various communication links therebetween.

In one embodiment, each of the various managed network elements, communication links, subnets, protocols, services, applications, layers and any other element, object or portion thereof within the Long Term Evolution (LTE) network is represented as data object associated with a plurality of attributes defining its respective properties and/or features. In this manner, any changes to attributes, properties and/or features associated with a managed network element may change the operation of the network element. Stated differently, any changes to the attributes, properties and/or features impact the function and/or operation of the network element as well as other network elements within the managed network.

Various embodiments provide a mechanism by which the impact of a proposed (or actual) change to one or more attributes, properties and/or features associated with a managed network element may be assessed. In this manner, the impact of the one or more proposed attribute changes may be used to help determine whether or not that change is appropriate in terms of the purpose of the managed network element, the interaction of the managed network element with other network elements and so on.

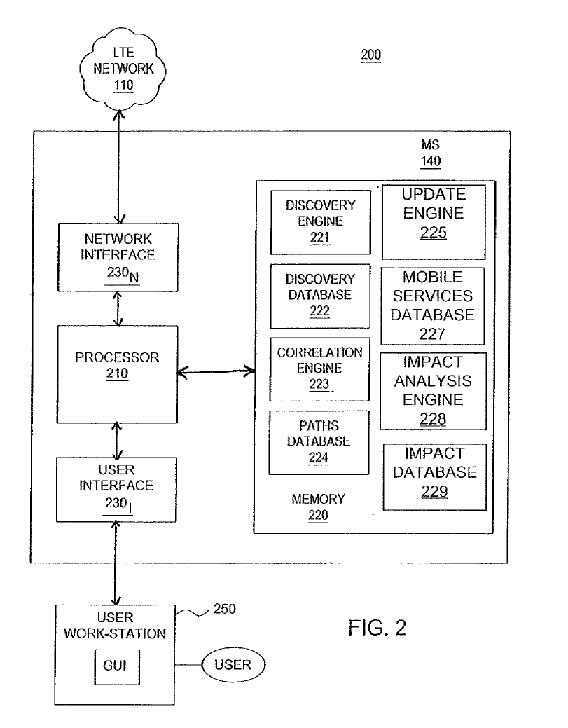

FIG. 2 depicts an exemplary management system suitable for use as the management system of FIG. 1. As depicted in FIG. 2, MS 140 includes one or more processor(s) 210, a memory 220, a network interface 230N, and a user interface 2301. The processor(s) 210 is coupled to each of the memory 220, the network interface 230N, and the user interface 2301.

The processor(s) 210 is adapted to cooperate with the memory 220, the network interface 230N, the user interface 2301, and the support circuits 240 to provide various management functions for LTE network 110.

The memory 220, generally speaking, stores programs, data, tools and the like that are adapted for use in providing various management functions for LTE network 110. The memory includes a Discovery Engine (DE) 221, a Discovery Database (DD) 222, a Correlation Engine (CE) 223, a Paths Database (PD) 224, an Update Engine (UE) 225, a Mobile Services Database (MSD) 227, an Impact Analysis Engine (IE) 228, and an Impact Database (ID) 229.

In one embodiment, the DE 221, CE 223, UE 225 and IE 228 are implemented using software instructions which may be executed by processor (e.g., processor(s) 210) for performing the various management functions depicted and described herein.

The DD 222, PD 224, MSD 227 and ID 229 each store data which may be generated by and used by various ones and/or combinations of the engines and tools of memory 220. The DD 222, PD 224, MSD 227 and ID 229 may be combined into a single database or implemented as respective databases, memory structures and/or portions thereof. Either of the combined or respective databases may be implemented as single databases or multiple databases in any of the arrangements known to those skilled in the art.

Although depicted and described with respect to an embodiment in which each of the engines and databases are stored within memory 120, it will be appreciated by those skilled in the art that the engines and databases may be stored in one or more other storage devices internal to MS 140 and/or external to MS 140. The engines and databases may be distributed across any suitable numbers and/or types of storage devices internal and/or external to MS 140. The memory 220, including each of the engines and/or databases of memory 220, is described in additional detail herein below.

The network interface 230N is adapted to facilitate communications with LTE network 110. For example, network interface 230N is adapted to receive information from LTE network 110 (e.g., discovery information adapted for use in determining the topology of the LTE network, results of test initiated by MS 140 to LTE network 110, and the like, as well as any other information which may be received by MS 140 from LTE network 110 in support of the management functions performed by MS 140). Similarly, for example, network interface 230N is adapted to transmit information to LTE network 110 (e.g., discovery requests for discovering information adapted for use by MS 140 in determining the topology of LTE network, audits request for auditing portions of LTE network 110, and the like, as well as any other information which may be transmitted by MS 140 to LTE network 110 in support of the management functions performed by MS 140).

The user interface 2301 is adapted to facilitate communications with one or more user workstations (illustratively, user workstation 250), for enabling one or more users to perform management functions for LTE network 110. The communications include communications to user workstation 250 (e.g., for presenting imagery generated by MS 140) and communications from user workstation 250 (e.g., for receiving user interactions with information presented via user workstation 250). Although primarily depicted and described as a direct connection between MS 140 and user workstation 250, it will be appreciated that the connection between MS 140 and user workstation 250 may be provided using any suitable underlying communication capabilities, such that user workstation 250 may be located proximate to MS 140 (e.g., such as where both MS 140 and user workstation 250 are located within a Network Operations Center (NOC)) or remote from MS 140 (e.g., such as where communications between MS 140 and user workstation 250 may be transported over long distances).

Although primarily depicted and described herein with respect to one user workstation, it will be appreciated that MS 140 may communicate with any suitable number of user workstations, such that any number of users may perform management functions for LTE network 110 (e.g., such as where a team of technicians at a NOC access MS 140 via respective user workstations for performing various management functions for LTE network 110). Although primarily depicted and described with respect to user workstations, it will be appreciated that user interface 2301 may be adapted to support communications with any other devices suitable for use in managing LTE network 110 via MS 140 (e.g., for displaying imagery generated by MS 140 on one or more common NOC display screens, for enabling remote Virtual Private Network (VPN) access to MS 140 by users via remote computers, and the like, as well as various combinations thereof). The use of user workstations to perform management functions via interaction with a management system will be understood by one skilled in the art.

As described herein, memory 220 includes the DE 221, DD 222, CE 223, PD 224, UE 225, MSD 227, IAE 228 and ID 229, which cooperate to provide the various functions depicted and described herein. Although primarily depicted and described herein with respect to specific functions being performed by and/or using specific ones of the engines and/or databases of memory 220, it will be appreciated that any of the management functions depicted and described herein may be performed by and/or using any one or more of the engines and/or databases of memory 220.

Discovery Engine

The discovery engine (DE) 221 is generally adapted for providing network discovery functions for discovering information about LTE network 110. Generally speaking, the DE 221 performs a discovery process in which configuration information, status/operating information and connection information regarding the elements and sub-elements forming the network is gathered, retrieved, inferred and/or generated as will be discussed in more detail below.

The discovery process may be dynamic in that the underlying elements, sub-elements and links within the LTE network may change over time due to local network adaptations, rerouting, failures, degradations, scheduled maintenance and the like. Thus, the DE 221 may be invoked after a network change is detected or caused.

At a first discovery level, the network management system (NMS) uses any legacy database information to discover the various elements (and the corresponding sub-elements) forming the network to be managed. That is, some of this discovery comprises the use of existing database information which provides a general blueprint of the network to be managed. Information in such a database includes information associated with the major functional elements forming a network, the major pipes or conduits established within the network and so on. While such information may be extremely detailed, the information does not reflect path-level network operation.

At a second discovery level, the network management system requests configuration information, status/operating information and connection information from each of the network elements within the managed network. The requested information includes information useful in determining the specific switches, ports, buffers, protocols and the like within the network elements that support the various traffic flows.

Configuration information comprises information identifying a network element, the function and/or configuration of the network element, the function and/or configuration of the sub-elements forming a network element and so on. Configuration information illustratively includes, but is not limited to, information identifying the type of network element, protocols supported by the network element, services supported by the network element and so on. Configuration information illustratively includes information attending to the various sub-elements within the network element, such as the input ports, switches, buffers, and output ports and so on associated with the sub-elements forming a network element.

Status/operating information comprises status/operating information associated with the operating state of the network element and/or the sub-elements forming a network element. Status/operating information illustratively includes, but is not limited to, information providing operating status/alarm indicators, including information pertaining to metrics such as packet count, utilization level, component pass/fail indication, bit error rate (BER) and the like.

Connection information comprises information useful in ascertaining or inferring the connections between network elements and/or sub-elements, such as the source of data received from the network element or its sub-elements, the destination of data transmitted by the network element or its sub-elements and so on. Connection information illustratively includes, but is not limited to, source address information associated with received packets, destination address information associated with transmitted packets, protocol information associated with packet flows, service information associated with packet flows, deep packet inspection results data and the like.

At a third discovery level, the network management system uses the discovered information to form a detailed framework representing each of the elements, sub-elements and links forming the infrastructure of the network, as well as their respective and various interconnections.

Generally speaking, the DE 221 may discover any suitable information associated with LTE network 110, which may be referred to collectively herein as discovery information, and further divided into configuration information, status/operating information and connection information.

In one embodiment, for example, DE 221 discovers components of the LTE network 110 and information associated with components of the LTE network 110. The components of LTE network 110 that are discovered by DE 221 may include any components, such as network elements (EPC network elements, non-EPC network elements, and the like), sub-elements of network elements (e.g., chassis, traffic cards, control cards, interfaces, ports, processors, memory, and the like), communication links connecting network elements, interfaces/sessions that support communications between network elements (e.g., LTE-Uu sessions, S* sessions, and the like), reference points, functions, services, and the like, as well as combinations thereof.

Correlation Engine

The CE 223 provides correlation of information used to support various management functions depicted and described herein. The CE 223 utilizes configuration information, status/operations information and/or connections information, illustratively provided by the DE 221 and stored within the DD 222, to correlate discovered network element, sub-element and link functions to specific customer traffic flows and/or paths supporting customer services. That is, using the framework representing each of the elements, sub-elements and links within the network and their various interconnections, the CE 223 correlates each customer service, traffic flow and/or EPS-path to the specific elements, sub-elements and links necessary to support the customer service, traffic flow and/or path.

The correlation process may be dynamic in that, for any given path, the underlying elements, sub-elements and links supporting that path may change over time due to local network adaptations, rerouting, failures, degradations, scheduled maintenance and the like.

The CE operates to maintain a current representation of the necessary supporting infrastructure associated with each customer service, traffic flow and/or path. By providing this representation, efforts responsive to customer service failure or degradation can be focused on the specific element, sub-element and link functions supporting the impacted customer service. Similarly, efforts responsive to element, sub-element and link function failure or degradation can be focused on the specific customers and/or services supported by the impacted element, sub-element and link function.

Typically, only a small subset of the sub-elements within a particular element is necessary to support a particular path. Thus, a failure associated with other sub-elements within an element does not impact that particular path. By correlating to each path only those elements necessary to support the path, the processing/storage burdens associated with managing individual paths are reduced by avoiding processing/storage requirements associated with nonessential (from the perspective of a particular path) elements.

In one embodiment, CE 223 may process discovery information stored in DD 222 for purposes of determining the underlying transport elements supporting the paths of LTE network 110, which is then stored in PD 224. In one embodiment, the path correlated transport element information determined by CE 223 and stored in PD 224 include EPS-related paths of LTE network 110.

In general, an EPS-related path is a path that is a transport mechanism that represents a peering relationship between two EPS reference points, where an EPS reference point is a termination point for any node of LTE network 110 that implements one or more of the protocols present in the 4G specification (e.g., using GTP, PMIP, or any other suitable protocols, and the like, as well as combinations thereof).

The path correlated transport element information may comprise network elements, communications links, subnets, protocols, services, applications, layers and any portions thereof. These transport elements may be managed by the network management system or portions thereof. The network management system may simply be aware of these transport elements.

As depicted and described herein, EPS reference points may include: for an eNodeB (S1-u, S1-MME, X2, and the like); for an SGW 112 (S1-u, S5158, S11, Gxs, and the like); for a PGW (S5/S8, SGi, SGx, S7, S2a, S2b, S2c, and the like); for an MME (S1-MME, S11, S10, and the like); and for a PCRF (S7). Thus, EPS-related paths correspond generally to the various S* sessions between the eNodeBs and EPC nodes (e.g., a path between an eNodeB 111 and an SGW 112 in the case of S1-u reference points, a path between an SGW 112 and PGW 113 in the case of S5/S8 reference points, a path between an eNodeB 111 and an MME 114 in the case of S1-MME reference points, and the like).

In one embodiment, the path correlated transport element information determined by CE 223 and stored in PD 224 include other types of paths (e.g., paths other than EPS-related paths). For example, the other types of paths may include one or more of: (1) paths that form sub-portions of EPS-related paths (e.g., where an EPS-related path is supported using underlying communications technology, the path that forms a sub-portion of the EPS-related path may be a path associated with the underlying communications technology, (2) paths that include multiple EPS-related paths (e.g., paths from eNodeBs to PGWs that traverse both S1-u and S5/S8 sessions, paths from UEs to SGWs that traverse both LTE-Uu sessions and S1-u sessions, and the like), and (3) end-to-end mobile session paths (e.g., paths between UEs and IP networks). The path correlated transport element information determined by CE 223 and stored in PD 224 may include other information correlated with various types of paths.

The path correlated transport element information determined by the CE 223 and stored in the PD 224 may be determined using any suitable processing.

Update Engine

The update engine (UE) 225 is generally adapted for providing network update functions associated with the addition, deletion or modification of any mobile service component within the LTE network 110.

After the network manager discovers the network elements and their connections as previously described, the network manager may identify the LTE type network elements, such as PGW, SGW, eNodeB, MME, PCRF, SGSN and the like. Of primary interest are the PGW, SGW and eNodeB. Between these network elements are EPS paths having associated reference points on the network elements, where the EPS paths/reference points are denoted as S1-u, S5, SGi and so on. Thus, stored in a database is a collection of modular components, of type “network element” for the PGW, SGW, eNodeB and the like, or type “connector” for the EPS paths.

Generally speaking, one gateway instance is provided at a Network Element such as a single PGW or SGW mapped to one Network Element; and such mapping is reflected in the database representation of the Mobile Services supported by the Network Element, PGW, SGW and the like. However, in various embodiments multiple Gateway Instances may be provided at a single Network Element. Thus, the terms “network element,” “site,” “mobile gateway site” and “mobile service site” are intended to be broadly construed to reflect the use of single or multiple gateway instances.

The network manager may define a plurality of Mobile Services by connecting or concatenating instances of the two types of modular components (i.e., network elements and connectors), such as the sequence of network elements and connectors between a customer served via a specific eNodeB and a data stream or other service received from the IP core network at the PGW. Thus, in one embodiment, a mobile service comprises a structure or wrapper containing a concatenated sequence of network elements and connectors.

A Mobile Service may be defined in terms of a particular customer, a particular eNodeB, a particular APN, a particular service provider, a particular content source, a particular customer and so on. A mobile service may include one or more instances of an EPS on a network element, such as one or more of an SGW or a PGW on a single or common network element. A mobile service may be supported by multiple network topologies.

As previously noted, the DD 222, PD 224, MSD 227 and ID 229 may be combined into a single database or implemented as respective databases, memory structures and/or portions thereof. Either of the combined or respective databases or caches may be implemented as single databases or multiple databases in any of the arrangements known to those skilled in the art.

For purposes of simplifying the discussion, it will be assumed that the MSD 227 is used to store a mobile services table in which each mobile service and the underlying paths and/or transport layer elements supporting the mobile service are defined. Any additions, deletions or modification to a mobile service, an underlying path supporting the mobile service, or an underlying transport layer element supporting a path or mobile service will result in corresponding additions, deletions or modification within the mobile services database 227 via a service update process such that the database entries in the mobile services database 227 are kept synchronized with the actual mobile services they represent.

Specifically, a mobile service is considered to be synchronized when the information stored within a network management database, such as a mobile services table within a database such as the MSD 227, matches the actual configuration information, status/operating information and connection information pertaining to the service elements or components supporting the mobile service.

When there is a change to the mobile service or one of its underlying components or elements, the database is out of sync. In this case, the mobile service and its underlying elements cannot be managed with the same degree of precision as when they are synchronized since the database information is or may be incorrect.

Therefore, whenever there is a change in a mobile service, or a transport layer element/sub-element supporting the mobile service, the database needs to be updated to reflect the change and remain synchronized.

Impact Analysis Engine

The impact analysis engine (IAE) 228 is generally adapted for providing an impact assessment indication associated with any proposed (or implemented) attribute change, such as the addition, deletion or modification of any network element attribute, transport layer infrastructure attribute, EPS path attribute or mobile service component attribute within the LTE network 110. Thus, the impact analysis engine 228 may be used in conjunction with any of the discovery engine 221, correlation engine 223 and update engine 225.

Various functions performed by the impact analysis engine 228 include one or more of creation, modification and/or deletion of real objects or logical objects representing network elements, sub-elements, links or portions thereof (e.g., a Port, a Card, a Processor or other portion). Depending upon the logical objects, the operations of creation, modification and/or deletion of logical objects may be performed independently by the impact analysis engine 228 or in conjunction with other functional elements such as described herein area, For example, deleting a S1-mme link has an impact if an eNodeB is currently operationally up and communicating with the MME. Similarly, the creation of certain objects requires some modules on the Network Element to be restarted which is service impacting. The action associated with any object (Real or Logical (e.g., Interface, S1-mme link, Routing Protocol and the like)) is analyzed by the Impact Analysis Engine (228) as discussed herein, and may result in an Impact warning/summary and the like.

As discussed above, a database representation of a Mobile Service such as might be found in the mobile services database 227 contains objects representing Mobile Service Connectors such as EPS Paths, and Mobile Service Sites such as SGWs, PGWs, GGSNs, eNodeBs, UEs and the like. Similarly, a database representation of a transport layer infrastructure such as might be found in the discovery database 222 or paths database 224 includes object level representations of network elements, links, EPS paths and the like.

According to various embodiments, the database representations of the various objects in one or more of the previously described databases is augmented to include impact analysis data to provide, illustratively, additional criteria by which the validity or appropriateness of a proposed management system change to a property or feature of a managed network element may be evaluated.

According to various embodiments, the impact analysis engine to 28 may be invoked in response to discovery, correlation and/or update operations in which a modification is contemplated of a network element attribute, transport layer infrastructure attribute, EPS path attribute and/or mobile service component attribute.

In various embodiments, systems, methods and apparatus are provided wherein various network elements are associated with respective operational models derived from one or more static data sources (e.g., manufacturer data, third party data and the like) as well as one or more dynamic or deterministically derived data sources (e.g., historic operations data, third party data and the like). Information provided via each of the static and dynamic data sources

Each of the properties and/or features of a network element or other transport layer infrastructure, EPS path representation, mobile service component and the like is represented as a corresponding software object having various attributes within a data structure or model describing the network element, transport layer infrastructure, EPS path representation, mobile service component and the like. In various embodiments, such representative software objects comprise traditional database objects such as presently used in various network management systems. In other embodiments, such representative software objects adhere to a common or unified object model in which information provided by the static and/or dynamic data sources is conformed to a common or unified object model to simplify subsequent processing operations associated with the object-related data.

As a general proposition, any changes to properties and/or features associated with the device necessarily change the operation of the device. It is therefore important for any such changes in the operation of the device to be compatible with the purpose of the device, the interaction of the device with other devices and so on. Moreover, it is desired to determine in real time or on-the-fly manner the impact of any changes to attributes associated with any device.

An undesirable result may be known at the time of the design of the network element or determined over time based upon the operational history of the network element itself, groups of related network elements or the systems within which these network elements operate. These rules may be broken or overwritten, but they are designed to inform network operations personnel that a proposed attribute change may have a negative effect and, importantly, the operational aspects associated with the negative effect.

It is desirable to deterministically know exactly what impact an attribute change will cause. This may be based on a predicted set of rules. For example, self-learning may be provided in which changes that result in a negative effect are identified and incorporated into subsequent impact analysis of proposed attribute changes. The self-learning algorithms may build upon the initial object model in the network as defined by the rules, or based upon other rules/procedures.

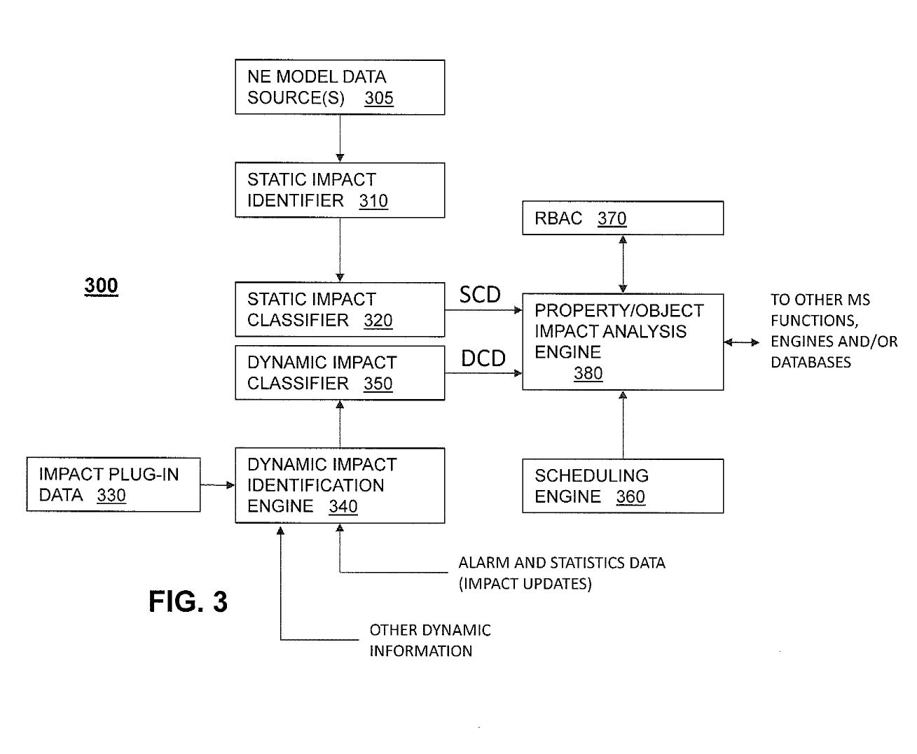

FIG. 3 depicts a graphical representation of processes associated with various embodiments. In particular, a property/object impact analysis engine 380 processes static classification data (SCD) and dynamic classification data (DCD) associated with network element objects to derive thereby attribute change impact information suitable for use by various other management system functions, engines and/or databases.

Specifically, one or more network element (NE) data sources 305 provides information defining the various properties or attributes of a network element representative object, such as the features, characteristics and so on associated with the NE. Network element data sources 305 may comprise network element manufacturers, systems integrators, network operators, competitive or benchmark device data and so on. The network element data sources 305 may be implemented using local databases, remote databases and so on. Generally speaking, network element data sources 305 comprise any source of information useful in defining the various properties or attributes of the network element.

A static impact identifier 310 associates the information defining the various properties or attributes of a particular network element with a series of simple or complex rules to define the operation of the particular network element in response to various property or attribute changes. These rules may also define constraints associated with property or attribute changes that are likely to yield an undesirable result. Thus, the static impact identifier 310 generates information identifying the impact of specific property or attribute changes to a network element based upon a priori knowledge of the network element.

A static impact classifier 320 operates to classify the impact of a rule or rule change in a manner suitable for use by the property/object impact analysis engine 380. For example, static impact classifier 320 may provide additional static rules, modify existing static rules and so on to provide static classification data (SCD) in a form suitable for use by the property/object impact analysis engine 380.

In various embodiments, the static impact classifier 320 operates to group or classify attribute changes in terms of the affected network elements, network element portions, network operators, service classes and so on. As will be discussed in more detail below, such classification enables a request for a first series of actions received by a network operator to be atomically linked to a request for a second series of actions received by the network operator such that multiple reboots/resets are avoided.

A dynamic impact identification engine 340 receives impact plug-in data 330, feedback information such as impact-representative alarm and statistics data, and/or other deterministically derived or calculated impact data associated with network elements.

In various embodiments, the dynamic impact identification engine 340 examines and object hierarchy and various rules provided via impact plug-in data 330. The dynamic impact identification engine 340 operates to analyze attribute change impacts associated with network elements as well as refine static or dynamic rules intended to describe the impact of such attribute changes. In essence, the dynamic impact identifier 340 provides a self-learning or self-improving mechanism for identifying new impact-related rules and/or modifying existing impact-related rules.

In various embodiments, the dynamic impact identifier 340 further identifies or refines the specific attribute changes associated with a network object model that will result in a negative impact. In various embodiments, a range of attribute changes and/or magnitude of attribute changes associated with a negative impact is identified. In various embodiments, a sequence of attribute changes and/or timing of such attribute changes associated with a negative impact is identified. In various embodiments, changes to static or dynamic rules associated with a negative impact are identified.

In one embodiment, the dynamic impact identifier 340 modifies existing rules in response to favorable analysis, such by updating static rules used by the property/object impact analysis engine 380 in response to new information based upon analysis of prior attribute changes.

The dynamic impact identifier 340 provides the results of its analysis to a dynamic impact classifier 350, which operates to classify the impact of the rule change in a manner suitable for use by the property/object impact analysis engine 380. For example, dynamic impact classifier engine 350 may provide additional rules, modified existing rules and so on in a predefined type or data structure which readily augments the data structures used by the property/object impact analysis engine 180. In this manner, a refined set of existing and/or updated rules, operating parameters and other information associated with the network element may be provided to the property/object impact analysis engine 380.

In various embodiments, the dynamic impact classifier 350 operates to group or classify attribute changes in terms of the affected network elements, network element portions, network operators, service classes and so on. As will be discussed in more detail below, such classification enables a request for a first series of actions received by a network operator to be atomically linked to a request for a second series of actions received by the network operator such that multiple reboots/resets are avoided.

The property/object impact analysis engine 380 applies the various static and/or dynamic rules associated with each attribute change to identify the of negative impact (if any) associated with the attribute change and communicate this information to other management system functions, engines, databases and the like such that a network operator or other entity contemplating particular attribute changes may be informed of the likely negative impact of such changes.

The negative impact of actually changes may be communicated as one of a plurality of impact levels, such as a “no impact” level, a “moderate impact” level and a “high impact” level. Additional levels may also be defined. Generally speaking, a “high impact” level may be defined as requiring a reboot or system initialization of a network element which will have the effect of disrupting services, a “moderate impact” level may be defined as any other type of negative impact short of the “no impact” level. In the case of an operator interacting with a graphical user interface (GUI) each of these levels may be color-coded such as by red, yellow and green coating four, respectively, high-impact, moderate impact and no impact attribute changes.

In various embodiments, the property/object impact analysis engine 380 provides expected alarm and/or statistical information consistent with a determined negative impact of an attribute change. In various embodiments, expected alarm and/or statistical information is stored in, illustratively, the impact database 226 for subsequent comparison to actual alarm and/or statistical information. Specifically, by comparing the expected alarm and/or statistical data to actual alarm and/or statistical data associated with a determined negative impact as defined by one or more static or dynamic rules, the accuracy of the one or more static or dynamic rules may be assessed. This assessment process is part of a dynamic rules assessment process implemented within either or both of the property/object impact analysis engine 380 or dynamic impact identification engine 340.

In various embodiments, the property/object impact analysis engine 380 communicates either or both of the expected or actual alarm and/or statistical data to the network operator, network operator customer, carrier and the like so that better attribute change decisions may be made in the future. That is, the various embodiments, the property/object impact analysis engine provides a feedback mechanism to inform carriers of negative (and/or positive) effects of proposed changes in various attributes so that they may manage their networks in a more efficient manner.

This information may be propagated in a visual manner, such as by providing overlay imagery on a graphical user interface indicative of a negative result if a proposed attribute change is implemented by an operator. For example, a red exclamation point may indicate that a proposed attribute change will definitely cause a problem, while a yellow triangle may indicate that a proposed attribute change may cause a problem.

### Intelligent Deployment to Minimize Overall Impact.

Various embodiments are adapted to accept some negative impact associated with attribute changes while minimizing the overall impact associated with the attribute changes. For example, various embodiments provide a property/object classification based upon impact analysis such as caused by a network element reboot, network element reset, or other identified impact effect. The impacted service may be determined using dynamic analysis techniques and/or self-learning techniques based upon the rules initially provided by systems engineering teams.

In one embodiment, a scheduling engine 360 operates to schedule one or more rule changes and/or attribute changes such that a negative impact is minimized. For example, if a number of attributes are to be changed with respect to a single eNodeB, and each attribute change requires a reboot or device reset, then the scheduling engine 360 may be used to avoid or reduce the required number of reboots of the eNodeB necessary to implement the various attribute changes. That is, the scheduling engine 360 operates to ensure that the eNodeB is rebooted and/or reset the minimum amount of times necessary to support the allowed change in attributes.

In one embodiment, the scheduling engine 360 has the ability to delay the execution of series of attribute modifications until the occurrence of a maintenance window. In this manner, the service impact felt by users due to the attribute modifications may be reduced (by impacting users once for multiple modifications) or at least scheduled for a time of light usage by users.

In one embodiment, the Scheduling Engine 360 is used to provide a “grace” period or “execution delay” period for reconsidering certain operations that would impact service. For example, any Class 1 (e.g., Critical Impact) modification (attribute change, creation of objects, deletion of instances, . . . ) is followed by a delay of 10 minutes, 20 minutes or some other (configurable) time period prior to deployment, such that the operator or system itself may rescind the deployment if the deployment should not be executed for some reason. Different impact classes (e.g., non-critical impact, impact on critical customer and the like) may be defined and associated with various time delays or no time delays. Moreover, the specific time delays may be adapted in response to service level agreement requirements, the skill or seniority of a network operator and so on.

In one embodiment, each attribute change requiring a network element reboot or reset operation indicates to the scheduling engine 160 that such an operation is necessary and, after all of the changes have been made, the scheduling engine 160 causes the network element to reboot or reset as minimally necessary to provide the desired changes. The scheduling engine operates to “back off” or otherwise delay reboot/reset operations where multiple reboot/reset operations will be necessary to achieve the goals of one or more service providers authorized to modify a particular network element in need of reboot/reset.

In one embodiment, all of the reboot operations associated with all of the attribute changes are atomically linked so that a single reboot operation is invoked to implement all of them. For example, changes in attributes and the like are grouped or classified across network elements, network element portions, operators and the like. In this manner, a request for a first series of actions received by network operators is atomically linked to a second series of actions received by the network operator or another network operator such that multiple reboots/resets are avoided.

Thus, in addition to minimizing the impact of specific attribute change requests, the aggregate impact of multiple attribute change requests is also minimized to the extent possible, even where those multiple attribute change requests come from different service providers.

### Intelligent Limitations to Minimize Unnecessary Impact.

In one embodiment, a role-based access control (RBAC) module 370 operates to ensure that a proposed attribute change does not cause the network element to enter an operating mode exceeding some defined parameter, such as a minimum or maximum quality of service parameter and the like. The role may be defined by a service level agreement, operators agreement, or other mechanism. The role may be defined in terms of the specific network operator; namely, a junior network operator may lack the authority to implement certain attribute changes were such changes may produce a negative impact while a senior network operator may have an override authority. The role may simply be that certain negative results from attribute change are not to be tolerated and, therefore, any attribute change likely to cause a prohibited result will be restricted. Examples of this type of activity may include logical additions or deletions of attributes or network elements within a tree.

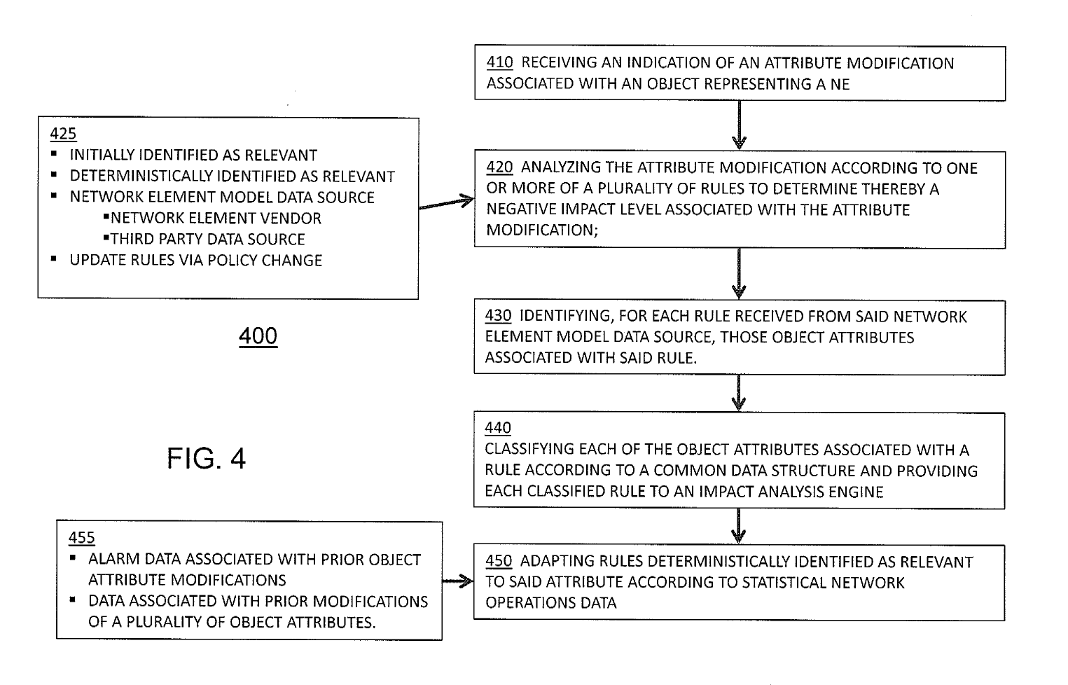

FIG. 4 depicts a flow diagram of a method according to an embodiment.

At step 410, an indication of a modification of an attribute associated with an object representing a network element is received.

At step 420, the attribute modification is analyzed according to one or more of a plurality of rules to determine thereby a negative impact level associated with the attribute modification. Referring to box 425, the rules may include rules initially identified as relevant to said attribute and/or rules deterministically identified as relevant to said attribute. In addition, the rules may have been derived from a network element model data source, such as a network element vendor or third party data source. In various embodiments, rules may also be updated via policy changes and/or various other network management mechanisms.

At step 430, for each rule received from a network element model data source, those object attributes associated with the rule are identified.

At step 440, each of the object attributes associated with a rule is classified according to a common data structure and provided to an impact analysis engine for further processing.

At step 450, various rules such as those deterministically identified as relevant to an attribute are adapted according to statistical network operations data. Referring to box 455, such network operations data may comprise alarm data associated with prior object attribute modifications, data associated with prior modifications of a plurality of other or related object attributes and so on.

FIG. 5 depicts a high-level block diagram of a computer suitable for use in performing functions described herein.

As depicted in FIG. 5, computer 500 includes a processor element 503 (e.g., a central processing unit (CPU) and/or other suitable processor(s)), a memory 504 (e.g., random access memory (RAM), read only memory (ROM), and the like), a cooperating module/process 505, and various input/output devices 506 (e.g., a user input device (such as a keyboard, a keypad, a mouse, and the like), a user output device (such as a display, a speaker, and the like), an input port, an output port, a receiver, a transmitter, and storage devices (e.g., a tape drive, a floppy drive, a hard disk drive, a compact disk drive, and the like)).

It will be appreciated that the functions depicted and described herein may be implemented in software and/or in a combination of software and hardware, e.g., using a general purpose computer, one or more application specific integrated circuits (ASIC), and/or any other hardware equivalents. In one embodiment, the cooperating process 505 can be loaded into memory 504 and executed by processor 503 to implement the functions as discussed herein. Thus, cooperating process 505 (including associated data structures) can be stored on a computer readable storage medium, e.g., RAM memory, magnetic or optical drive or diskette, and the like.

It will be appreciated that computer 500 depicted in FIG. 5 provides a general architecture and functionality suitable for implementing functional elements described herein or portions of the functional elements described herein.

It is contemplated that some of the steps discussed herein as software methods may be implemented within hardware, for example, as circuitry that cooperates with the processor to perform various method steps. Portions of the functions/elements described herein may be implemented as a computer program product wherein computer instructions, when processed by a computer, adapt the operation of the computer such that the methods and/or techniques described herein are invoked or otherwise provided. Instructions for invoking the inventive methods may be stored in tangible and non-transitory computer readable medium such as fixed or removable media or memory, transmitted via a tangible or intangible data stream in a broadcast or other signal bearing medium, and/or stored within a memory within a computing device operating according to the instructions.

While the foregoing is directed to various embodiments of the present invention, other and further embodiments of the invention may be devised without departing from the basic scope thereof. As such, the appropriate scope of the invention is to be determined according to the claims, which follow.

What is claimed is:

1. A method for use in a network management system including a database for storing objects representing network elements or portions thereof, the method comprising:
receiving an indication of an attribute modification associated with an object representing a network element;
analyzing the attribute modification according to one or more of a plurality of rules to determine thereby a negative impact level associated with the attribute modification;
said rules comprising rules initially identified as relevant to said attribute and rules deterministically identified as relevant to said attribute.

2. The method of claim 1, further comprising updating one or more of said rules via a policy change.

3. The method of claim 1, wherein said rules initially identified as relevant to said attribute are received from a network element model data source.

4. The method of claim 3, wherein said network element model data source is selected from the group comprising: network element manufacturer; systems integrator; network operator; competitive device data; and benchmark device data.

5. The method of claim 3, further comprising identifying, for each rule received from said network element model data source, those object attributes associated with said rule.

6. The method of claim 5, further comprising:
classifying each object attributes associated rule according to a common data structure; and
providing each classified rule to an impact analysis engine.

7. The method of claim 1, wherein said rules deterministically identified as relevant to said attribute are adapted according to statistical network operations data.

8. The method of claim 7, wherein said statistical network operations data comprises at least alarm data associated with prior modifications of said object attribute.

9. The method of claim 8, wherein said statistical network operations data comprises data associated with a prior modifications of a plurality of object attributes.

10. The method of claim 1, further comprising scheduling for execution during a maintenance window each of a plurality of network element attribute changes.

11. The method of claim 1, further comprising scheduling for execution during a common time period each of a plurality of network element attribute changes requiring reset of a network element.

12. The method of claim 1, further comprising scheduling for execution in a predefined sequence each of a plurality of network element attribute changes

13. The method of claim 1, further comprising gathering actual network impact data associated with one or more attribute changes.

14. The method of claim 13, further comprising adapting one or more rules according to the gathered actual network impact data.

15. The method of claim 1, further comprising determining whether a proposed attribute change is within a defined network operations parameter.

16. The method of claim 15, wherein said defined network operations parameter is associated with a network operator authorization level.

17. The method of claim 15, wherein said defined network operations parameter is associated with one or more of a service level agreement, an operators agreement and a prohibited result.

18. An apparatus for use in a mobile services management system including a database for storing objects representing network elements or portions thereof, the apparatus comprising:
a processor configured for:
receiving an indication of an attribute modification associated with an object representing a network element;
analyzing the attribute modification according to one or more of a plurality of rules to determine thereby a negative impact level associated with the attribute modification;
said rules comprising rules initially identified as relevant to said attribute and rules deterministically identified as relevant to said attribute.

19. A tangible and non-transitory computer readable medium computer readable medium including software instructions which, when executed by a processer, perform a method, comprising:
receiving an indication of an attribute modification associated with an object representing a network element;
analyzing the attribute modification according to one or more of a plurality of rules to determine thereby a negative impact level associated with the attribute modification;
said rules comprising rules initially identified as relevant to said attribute and rules deterministically identified as relevant to said attribute.

20. A computer program product, wherein a computer is operative to process software instructions which adapt the operation of the computer such that computer performs a method, comprising:
receiving an indication of an attribute modification associated with an object representing a network element;
analyzing the attribute modification according to one or more of a plurality of rules to determine thereby a negative impact level associated with the attribute modification;
said rules comprising rules initially identified as relevant to said attribute and rules deterministically identified as relevant to said attribute.
